(19) United States
(12) Patent Application Publication
(10) Pub. No.: US 2026/0137095 A1
(43) Pub. Date: May 21, 2026

(54) BEVERAGE, AND METHOD FOR PRODUCING SAME

(71) Applicant: KIRIN HOLDINGS KABUSHIKI KAISHA, Tokyo (JP)

(72) Inventors: Mihoko SUZUKI, Tokyo (JP); Yuko YOTSUMOTO, Tokyo (JP)

(73) Assignee: KIRIN HOLDINGS KABUSHIKI KAISHA, Tokyo (JP)

(21) Appl. No.: 18/704,139

(22) PCT Filed: Apr. 21, 2022
(86) PCT No.: PCT/JP2022/018355

§ 371 Date: Apr. 24, 2024

(30) Foreign Application Priority Data
Oct. 28, 2021 (JP) 2021-176891

(51) Int. Cl. A23C 9/123

(52) U.S. Cl. CPC A23C 9/123; A23V 2400/231

(57) ABSTRACT

An object of the present invention is to provide an acidic milk beverage with suppressed stuck feeling in throat after drinking, a method for producing the same, and the like. The present invention comprises a step of incorporating a JCM5805 strain in the production of an acidic milk beverage having a pH of 6 or less.

### TECHNICAL FIELD

The present invention relates to an acidic milk beverage with suppressed stuck feeling in throat after drinking, and a method for producing the same.

### BACKGROUND ART

In recent years, with the increase in health consciousness, there has been a growing interest in health-promoting food and beverages, and there is a growing need, for example, for fermented milk containing lactic acid bacteria as well as beverages containing lactic acid bacteria. It is known that after drinking acidic milk beverages, a feeling like some solid content is stuck in the back of the throat (stuck feeling) may occur.

Meanwhile, as technology using lactic acid bacteria in food and beverages, for example, Patent Document 1 discloses a method for improving coffee richness (rich flavor) by mixing dead bacterial cells of lactic acid bacteria or the like in a container-packed coffee beverage. Further, Patent Document 2 discloses a method for suppressing the sourness of citrus fruit juice by growing specific lactic acid bacteria (Leuconostoc sp. KS-0002) in the fruit juice to degrade citric acid in the fruit juice.

However, it has not been known that stuck feeling in throat after drinking acidic milk beverages can be suppressed by incorporating a JCM5805 strain into the acidic milk beverages.

### PRIOR ART DOCUMENTS

### Patent Documents

Patent Document 1: Japanese unexamined Patent Application Publication No. 2019-122316
Patent Document 1: Japanese unexamined Patent Application Publication No. 03-175977

### SUMMARY OF THE INVENTION

### Object to be Solved by the Invention

An object of the present invention is to provide an acidic milk beverage with suppressed stuck feeling in throat after drinking, a method for producing the same, and the like.

### Means to Solve the Object

As a result of intensive studies to solve the object of the present invention, the present inventors have surprisingly found that when a JCM5805 strain is incorporated into an acidic milk beverage, stuck feeling in throat after drinking the acidic milk beverage can be suppressed, and have completed the present invention.

That is, the present invention relates to, for example,
(1) an acidic milk beverage comprising a Lactococcus lactis subsp. lactis JCM5805 strain and having a pH of 6 or less;
(2) the acidic milk beverage according to the above (1), wherein a bacterial cell concentration of the JCM5805 strain in the acidic milk beverage is 5 billion cells/100 mL to 200 billion cells/100 mL;
(3) the acidic milk beverage according to the above (1) or (2), wherein the acidic milk beverage has a milk solids concentration of 0.5 to 2.5 wt %;
(4) a method for producing an acidic milk beverage having a pH of 6 or less, the method comprising a step of incorporating a JCM5805 strain in the production of the acidic milk beverage; and
(5) a method for suppressing stuck feeling in throat after drinking an acidic milk beverage having a pH of 6 or less, the method comprising a step of incorporating a JCM5805 strain in the production of the acidic milk beverage.

### Effect of the Invention

The present invention can provide an acidic milk beverage with suppressed stuck feeling in throat after drinking, a method for producing the same, and the like. Further, as a more preferred embodiment of the present invention, it is possible to provide an acidic milk beverage with suppressed stuck feeling in throat after drinking while maintaining the overall flavor, a method for producing the same, and the like.

### BRIEF DESCRIPTION OF DRAWING

FIG. 1 is a diagram showing the relationship between a Lactococcus lactis subsp. lactis JCM5805 strain and strains equivalent to the strain (strains derived from the strain and strains from which the strain is derived).

### MODE OF CARRYING OUT THE INVENTION

The present invention includes embodiments, such as
[1] an acidic milk beverage comprising a Lactococcus lactis subsp. lactis JCM5805 strain and having a pH of 6 or less (hereinafter also referred to as “the acidic milk beverage of the present invention”);
[2] a method for producing an acidic milk beverage having a pH of 6 or less, the method comprising a step of incorporating a JCM5805 strain in the production of the acidic milk beverage (hereinafter also referred to as “the production method of the present invention”); and
[3] a method for suppressing stuck feeling in throat after drinking an acidic milk beverage having a pH of 6 or less, the method comprising a step of incorporating a JCM5805 strain in the production of the acidic milk beverage (hereinafter also referred to as “the suppression method of the present invention”).

### (JCM5805 Strain)

The “JCM5805 strain” used in the production of the acidic milk beverage of the present invention may be live bacterial cells or dead bacterial cells as long as they are bacterial cells of the JCM5805 strain; however, dead bacterial cells of the JCM5805 strain are preferred. The JCM5805 strain may be a dried product or non-dried product of the JCM5805 strain; however, from the viewpoint of the desirability of storage stability and the like, preferred is a dried product of the JCM5805 strain (preferably a dried product of dead bacterial cells of the JCM5805 strain), and more preferred is a dry powder of the JCM5805 strain (preferably a dry powder of dead bacterial cells of the JCM5805 strain).

Although the method for preparing a dry powder is not specified, treatment such as freeze-drying, hot-air drying, or spray-drying can be used to prepare a dry powder, and powdering by spray-drying is preferred.

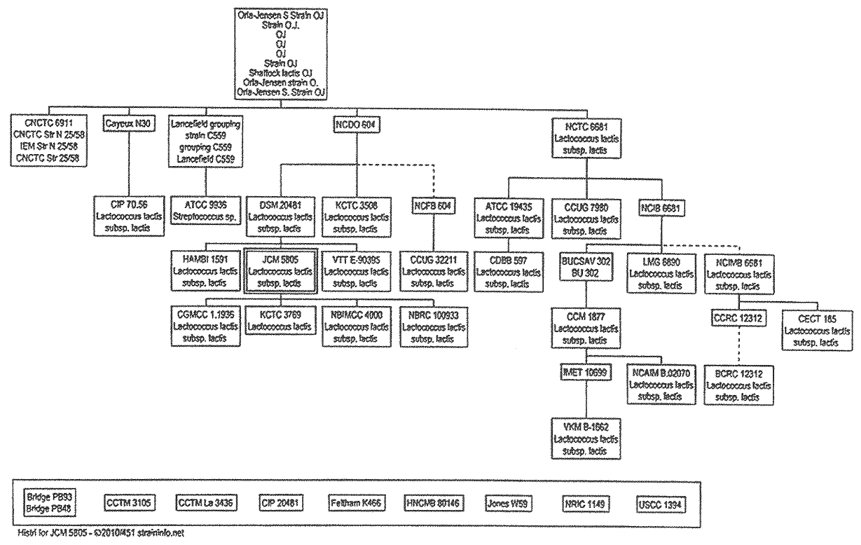

The “JCM5805 strain” in the present invention also includes strains equivalent to the JCM5805 strain as long as the effects of the present invention can be obtained. Here, such an equivalent strain refers to a strain derived from the JCM5805 strain (strain A), a strain from which the JCM5805 strain is derived (strain B), or a progeny strain of the strain A or strain B mentioned above. Equivalent strains may be stored in other strain preservation institutions. FIG. 1 shows strains derived from the JCM5805 strain, and strains from which the JCM5805 strain is derived. Even the strains equivalent to the JCM5805 strain shown in FIG. 1 can be used as the “JCM5805 strain” in the present invention as long as they have the effect of suppressing stuck feeling in throat after drinking acidic milk beverages.

The method for preparing bacterial cells of the JCM5805 strain is not particularly limited, and examples of the method for preparing live bacterial cells of the JCM5805 strain include a method of collecting bacterial cells by filtration, centrifugation, or the like from the medium in which the JCM5805 strain is cultured. Further, examples of the method for preparing dead bacterial cells of the JCM5805 strain include a method of collecting bacterial cells by filtration, centrifugation, or the like after sterilization of the culture medium in which the JCM5805 strain is cultured, and a method of collecting bacterial cells by filtration, centrifugation, or the like from the culture medium in which the JCM5805 strain is cultured, followed by sterilization, and optionally further followed by drying treatment and crushing treatment.

The means of sterilization is not particularly limited, and not only heating, but also conventional means to kill bacteria, such as ultraviolet and y-ray irradiation, can be used.

In the present invention, the bacterial cell concentration of the JCM5805 strain in the acidic milk beverage is not particularly limited as long as the effects of the present invention can be obtained; however, from the viewpoint of the effect of suppressing stuck feeling, the number of bacterial cells of the JCM5805 strain per 100 mL of the acidic milk beverage is, for example, “5 billion cells/100 mL” or more, and from the viewpoint of the effect of suppressing stuck feeling and the good balance of the overall flavor of the acidic milk beverage, the number of bacterial cells of the JCM5805 strain per 100 mL of the acidic milk beverage is preferably 40 billion cells/100 mL to 200 billion cells/100 mL, and more preferably 40 billion cells/100 mL to 100 billion cells/100 mL.

The number of bacterial cells of the JCM5805 strain can be measured by a direct spectroscopic method, a particle electrical sensing zone method, a PCR method, a flow cytometry method, or the like.

The number of bacterial cells per gram of the dried product of bacterial cells of the JCM5805 strain can be measured by the measurement method described above, and the amount of the JCM5805 strain mixed in the acidic milk beverage can be adjusted.

The number of bacterial cells of the JCM5805 strain in the acidic milk beverage can be measured by a genetic quantitative method, such as a direct spectroscopic method, a flow cytometry method, or a real-time PCR method. More precisely, a method that also takes into account the influence of particles derived from other raw materials in the beverage can be used.

### (Acidic Milk Beverage)

The acidic milk beverage of the present invention is not particularly limited as long as it is an acidic milk beverage comprising a Lactococcus lactis subsp. lactis JCM5805 strain and having a pH of 6 or less.

The “acidic milk beverage” in the present specification refers to a milk beverage having a pH of 6 or less. The “milk beverage” in the present specification includes “milk beverages” defined in the “Ministerial Ordinance on Ingredient Standards for Milk and Dairy Products” (hereinafter referred to as “the Milk Ministerial Ordinance”), but is not limited to such milk beverages and is not particularly limited as long as it is a beverage containing a milk component. Examples of the “milk component” include one or more contents selected from a non-fat milk solids content and a milk fat content. The “milk beverage” may be an alcohol-containing beverage, but is preferably an alcohol-free beverage.

### (Milk Solids Concentration)

In the present specification, the “milk solids content” means a combination of a milk fat content and a non-fat milk solids content.

The milk solids concentration of the acidic milk beverage of the present invention is not particularly limited as long as the effects of the present invention can be obtained; however, from the viewpoint of more easily resulting in stuck feeling in throat after drinking and enjoying more significance of the present invention, the milk solids concentration is, for example, 0.5 wt % or more, and from the viewpoint of the effect of suppressing stuck feeling and the good balance of the overall flavor, the milk solids concentration is preferably 0.5 to 2.5 wt %, and more preferably 1 to 2 wt %.

The ratio of the non-fat milk solids content and the milk fat content in the milk solids content contained in the acidic milk beverage of the present invention is not particularly limited, and the ratio (%) of the non-fat milk solids content in the milk solids content may be any of 0 to 100%, but is preferably, for example, 30 to 100%, 50 to 100%, or 70 to 100%.

The milk solids concentration of the acidic milk beverage of the present invention can be adjusted, for example, by adjusting the amount of milk raw materials used in the production of the acidic milk beverage. Examples of the “milk raw materials” include milk and a dairy product, and more specifically one or more members selected from the group consisting of cow's milk, buffalo milk, sheep's milk, goat's milk, horse's milk, concentrated milk, skim milk, skim concentrated milk, skim milk powder, partially skim milk powder, whole milk powder, fermented milk, cream, butter, buttermilk, condensed milk, lactose, a milk protein concentrate, and a whey protein concentrate; and preferably one or more members selected from the group consisting of cow's milk, concentrated milk, skim milk, skim concentrated milk, skim milk powder, partially skim milk powder, whole milk powder, fermented milk, and cream.

The milk solids concentration of the acidic milk beverage of the present invention can be measured by measuring the spectra of a reference liquid and a sample using Fourier transform mid-infrared rays and comparing differences in specific wavelength regions.

(pH)

The pH of the acidic milk beverage of the present invention is not particularly limited as long as it is 6 or less; however, from the viewpoint of more easily resulting in stuck feeling in throat after drinking and enjoying more significance of the present invention, the pH is preferably 5 or less, more preferably 4.5 or less, even more preferably 4 or less, and more preferably less than 4. The pH value is a value measured at 20° C.

The pH of the acidic milk beverage can be adjusted by a conventional method, such as addition of a pH adjuster.

The pH of the acidic milk beverage of the present invention can be measured by a conventional method using a pH meter or the like.

### (Optional Components)

In the acidic milk beverage of the present invention, any one or more of additives for beverages used in the production of regular container-packed beverages, such as acidulants, pigments, flavorings, fruit juices, sweetening ingredients (including high-intensity sweeteners), and food additives (e.g., antioxidants, preservatives, thickening stabilizers, emulsifiers, dietary fibers, pH adjusters, and antifoaming agents) may be added or may not be added.

### (Production of Acidic Milk Beverage of Present Invention)

The acidic milk beverage of the present invention can be produced by a method comprising a step of incorporating a JCM5805 strain in the production of an acidic milk beverage having a pH of 6 or less. As the production method of the present invention, a general method for producing an acidic milk beverage having a pH of 6 or less can be used, except for incorporating a JCM5805 strain in the production of an acidic milk beverage having a pH of 6 or less. Examples of such a general method include a method for preparing an acidic milk beverage (preferably a container-packed acidic milk beverage) through a mixing step, a filling step, and a heat sterilization step. In the production of the acidic milk beverage of the present invention, additives for beverages used in the formulation design of regular container-packed beverages may be added, and the timing of adding such additives is not particularly limited. As a general method for producing the acidic milk beverage or container-packed acidic milk beverage mentioned above, reference can be made to, for example, “Revised New Edition of Soft Drinks” (Korin Co., Ltd.) for more details.

Preferred examples of the “step of incorporating a JCM5805 strain” (i.e., step of incorporating a JCM5805 strain into the acidic milk beverage of the present invention) in the present invention include adding a JCM5805 strain so that the beverage contains the JCM5805 strain.

In the present invention, the timing of incorporating (preferably adding) a JCM5805 strain may be any stage of the production process of the acidic milk beverage as long as the effects of the present invention can be obtained. For example, a JCM5805 strain may be incorporated into the mixed liquid or water in the mixing step, or a JCM5805 strain may be incorporated into the mixed liquid immediately before or after the filling step into a container.

### (Container)

The acidic milk beverage of the present invention is preferably a container-packed acidic milk beverage. Such a container means a sealed container that can cut off the contact between its content and the outside air, and examples of the container include a metal can, a barrel container, a plastic bottle (e.g., a PET bottle and a cup), a paper container, a bottle, and a pouch container.

### (Heat Sterilization)

The acidic milk beverage of the present invention is preferably a heat-sterilized acidic milk beverage. The heat sterilization step may be performed before or after filling the container with the beverage.

As the heat sterilization method, various heat sterilization methods commonly used in the food field can be used, and examples include a method using a pasteurizer sterilizer, a hot-water spray type, hot-water storage type, or steam type retort sterilizer, or a tube type or plate type liquid continuous sterilizer.

The conditions of heat sterilization in the present invention are not particularly limited, and general conditions used for the heat sterilization of container-packed beverages can be used. Examples of such conditions include conditions of 65° C. to 120° C. and 10 seconds to 40 minutes.

(Acidic Milk Beverage with Suppressed Stuck Feeling in Throat after Drinking)

The acidic milk beverage of the present invention is an acidic milk beverage with suppressed stuck feeling in throat after drinking. In the present specification, the acidic milk beverage “with suppressed stuck feeling in throat after drinking” means an acidic milk beverage with suppressed stuck feeling in throat after drinking in comparison to an acidic milk beverage produced by the same production method using similar raw materials, except that a JCM5805 strain is not incorporated (hereinafter “also referred to as the control beverage of the present invention”). Such acidic milk beverages with “suppressed stuck feeling in throat after drinking” in the present specification preferably include an acidic milk beverage in which when the degree of suppression of stuck feeling in throat after drinking in comparison to the control beverage is evaluated on a three-level scale: “1: suppressed,” “2: slightly suppressed,” and “3: not suppressed,” the average score of evaluation is 1 or more and less than 2.5, and preferably 1 or more and 2 or less, and an acidic milk beverage in which the numerical value obtained by rounding off the average score of evaluation to the first decimal place is 1 or 2.

(Acidic Milk Beverage with Overall Flavor Maintained)

It is preferable for the acidic milk beverage of the present invention that stuck feeling in throat after drinking is suppressed, and that further the overall flavor is maintained. In the present specification, the acidic milk beverage “with overall flavor maintained” means that because the smell of sulfur derived from the JCM5805 strain is not excessively strong, the overall flavor disharmony of the acidic milk beverage is within an acceptable range. Such acidic milk beverages “with overall flavor maintained” in the present specification preferably include an acidic milk beverage in which when the overall flavor of the acidic milk beverage is evaluated on a four-level scale: “1: good,” “2: slightly good,” “3: slightly poor,” and “4: poor,” the average score of evaluation is 1 or more and less than 3.5, and preferably 1 or more and 3 or less, and an acidic milk beverage in which the numerical value obtained by rounding off the average score of evaluation to the first decimal place is 1 to 3, and preferably 1 or 2.

(Method for Suppressing Stuck Feeling in Throat after Drinking Acidic Milk Beverage)

The method for suppressing stuck feeling in throat after drinking the acidic milk beverage of the present invention is not particularly limited as long as it is a method for suppressing stuck feeling in throat after drinking an acidic milk beverage having a pH of 6 or less, the method comprising a step of incorporating a JCM5805 strain in the production of the acidic milk beverage.

The present invention will be described in more detail below with reference to Examples; however, the present invention is not limited to these Examples.

### EXAMPLES

### [Test 1] Influence of Mixing of Lactic Acid Bacteria on Stuck Feeling in Throat after Drinking Acidic Beverage

The following test was conducted to examine whether incorporating lactic acid bacteria into acidic beverages affects stuck feeling in throat after drinking the acidic beverages.

### (Preparation of Sample Beverages)

The components shown in Table 1 below were added and mixed with water at the blend concentrations shown in Table 1 to prepare sample acidic milk beverages 1 to 9, and the sample beverages were each placed in a container and subjected to heat sterilization treatment at 80° C. for 10 minutes. In any of the tests (Tests 1 to 3) in the Examples of the present application, the bacterial cell concentration (100 million cells/100 mL) of the JCM5805 strain in the beverage was measured by using a flow cytometer after preparing a sample by appropriate dilution with a PBS buffer (produced by TAKARA), followed by staining with thiazole orange using a BD Cell Viability Kit with BD Liquid Counting Beads (produced by Becton, Dickinson and Company) according to the protocol. In the tables, the bacterial cell concentration (100 million cells/100 mL) is expressed as an approximate number with two significant figures. As a control, an acidic milk beverage to which a JCM5805 strain was not added was used as the sample beverage of Test Example 1. An appropriate amount of anhydrous citric acid was added to each sample beverage to adjust the pH to 3.7. The milk solids concentration of all of the sample beverages 1 to 9 was 1.5 wt %, and the ratio of the non-fat milk solids content in the milk solids content was 100 wt % in all of the sample beverages.

TABLE 1

| Component | Blend concentration (wt %) |
|---|---|
| JCM5805 strain | shown in Table 2 |
| Skim milk powder | 1.3 |
| Fermented milk (sterilized) | 2.1 |
| Fructose glucose liquid sugar | 13 |
| Soybean polysaccharide | 0.1 |
| Pectin | 0.1 |
| Flavoring | 0.1 |

### (Sensory Evaluation of Sample Beverages)

Five trained sensory evaluators sensory-evaluated whether the stuck feeling in throat after drinking the sample beverages of Test Examples 2 to 9 was suppressed, in comparison to the sample beverage of Test Example 1, which did not contain a JCM5805 strain, based on the following evaluation criteria. The results are shown in Table 2 below. In any of the tests (Tests 1 to 3) in the Examples of the present application, when the stuck feeling and the overall flavor were sensory-evaluated, the evaluation scores of a sample beverage by the five sensory evaluators were averaged, and a numerical value obtained by rounding off the average score to the first decimal place was used as the evaluation score of the sample beverage.

<Evaluation Criteria for Degree of Suppression of Stuck Feeling in Throat after Drinking>

The degree of suppression in comparison to the sample beverage that did not contain a JCM5805 strain;
1: suppressed
2: slightly suppressed
3: not suppressed

In addition, five trained sensory evaluators sensory-evaluated the overall flavor of each of the sample beverages of Test Examples 2 to 9 as absolute evaluation based on the following evaluation criteria. The results are shown in Table 2 below.

### <Evaluation Criteria for Overall Flavor>

1: good
2: slightly good
3: slightly poor
4: poor

Furthermore, the results of evaluating the sample beverages of Test Examples 1 to 9 by the sensory evaluators without being bound by the evaluation criteria are shown in the comment column of Table 2.

TABLE 2

| | Test Example | | | | | | | | |
|---|---|---|---|---|---|---|---|---|---|
| | 1 | 2 | 3 | 4 | 5 | 6 | 7 | 8 | 9 |
| JCM5805 | 0 | 50 | 100 | 200 | 400 | 1000 | 2000 | 3000 | 5000 |
| strain | | | | | | | | | |
| (100 million | | | | | | | | | |
| cells/100 mL) | | | | | | | | | |
| pH | 3.7 | | | | | | | | |
| Skim milk | 1.3 | 1.3 | 1.3 | 1.3 | 1.3 | 1.3 | 1.3 | 1.3 | 1.3 |
| powder (%) | | | | | | | | | |
| Fermented | 2.1 | 2.1 | 2.1 | 2.1 | 2.1 | 2.1 | 2.1 | 2.1 | 2.1 |
| milk | | | | | | | | | |
| (sterilized) | | | | | | | | | |
| (%) | | | | | | | | | |
| Ratio (%) of | 100 | 100 | 100 | 100 | 100 | 100 | 100 | 100 | 100 |
| non-fat milk | | | | | | | | | |
| solids | | | | | | | | | |
| content in | | | | | | | | | |
| milk solids | | | | | | | | | |
| content | | | | | | | | | |
| Milk solids | 1.5 | 1.5 | 1.5 | 1.5 | 1.5 | 1.5 | 1.5 | 1.5 | 1.5 |
| concentration | | | | | | | | | |
| (%) | | | | | | | | | |
| Stuck feeling | Control | 2 | 2 | 2 | 1 | 1 | 1 | 1 | 1 |
| in throat | | | | | | | | | |
| Overall flavor | — | 1 | 1 | 1 | 1 | 1 | 2 | 3 | 4 |
| General | Stuck | Stuck | Stuck | Stuck | Stuck | Stuck | Stuck | Stuck | Stuck |
| comments | feeling | feeling was | feeling was | feeling was | feeling was | feeling was | feeling was | feeling was | feeling was |
| | was felt | slightly | slightly | slightly | suppressed | suppressed | suppressed, | suppressed, | suppressed, |
| | in | suppressed | suppressed | suppressed | | | but there | but there | but there |
| | throat | | | | | | was a slight | was a smell | was a |
| | after | | | | | | smell of | of sulfur | strong |
| | drinking | | | | | | sulfur | | smell of |
| | | | | | | | | | sulfur |

As can be seen from the results in Table 2, when a JCM5805 strain was incorporated at 5 billion cells/100 mL or more, the evaluation of stuck feeling was 1 or 2, indicating that a suitable suppressive effect on stuck feeling in throat after drinking the sample beverages was obtained. It was also shown that when a JCM5805 strain was incorporated at 40 billion cells/100 mL or more, a higher suppressive effect was obtained. On the other hand, when a JCM5805 strain was incorporated at 200 billion cells/100 mL, the evaluation of the overall flavor was 2 (slightly good), which was within the acceptable range; however, there was a slight smell of sulfur derived from the JCM5805 strain. When the concentration of a JCM5805 strain was further increased, the smell of sulfur increased. When a CM5805 strain was incorporated at 500 billion cells/100 mL, there was a strong smell of sulfur, and the evaluation of the overall flavor was lowered to 4 (poor).

As described above, when a JCM5805 strain was incorporated at 5 billion cells/100 mL or more, the evaluation of stuck feeling was 1 or 2, and a suitable suppressive effect on stuck feeling was obtained in any case; however, it was shown that from the viewpoint of a more suitable suppressive effect on stuck feeling and the good balance of the overall flavor, the JCM5805 strain was more preferably incorporated at 40 billion cells/100 mL to 200 billion cells/100 mL, and even more preferably 40 billion cells/100 mL to 100 billion cells/100 mL.

[Test 2] Influence of Milk Solids Concentration on Stuck Feeling in Throat after Drinking Acidic Beverage

The following test was conducted to examine whether the milk solids concentration of acidic milk beverages affects stuck feeling in throat after drinking the acidic beverages.

### (Preparation of Sample Beverages)

The components shown in Table 3 below were added and mixed with water at the blend concentrations shown in Table 3 to prepare sample acidic milk beverages 10 to 16, and the sample beverages were each placed in a container and subjected to heat sterilization treatment at 80° C. for 10 minutes. Skim milk powder and fermented milk (sterilized) were added at the addition rate (wt %) shown in Table 4. The milk solids concentration (wt %) of the sample beverages 10 to 16 and the ratio (wt %) of the non-fat milk solids content in the milk solids content were each as shown in Table 4.

An appropriate amount of anhydrous citric acid was added to each sample beverage to adjust the pH to 3.7. The sample beverage of Test Example 13 was the same as the sample beverage of Test Example 6 in Table 2.

TABLE 3

| Component | Blend concentration (wt %) |
|---|---|
| JCM5805 strain | 100 billion cells/100 mL |
| Skim milk powder | shown in Table 4 |
| Fermented milk (sterilized) | shown in Table 4 |
| Fructose glucose liquid sugar | 13 |
| Soybean polysaccharide | 0.1 |
| Pectin | 0.1 |
| Flavoring | 0.1 |

### (Sensory Evaluation of Sample Beverages)

Five trained sensory evaluators sensory-evaluated whether the stuck feeling in throat after drinking the sample beverages of Test Examples 10 to 16 was suppressed, based on the following evaluation criteria. The results are shown in Table 4 below.

For example, the sensory evaluation of the degree of suppression of stuck feeling in the sample beverage of Test Example 10 was performed using, as a control, a sample beverage that did not contain a JCM5805 strain in the composition of the sample beverage of Test Example 10. The sensory evaluation of the sample beverages of Test Examples 11 to 16 was also performed using, as controls, sample beverages that did not contain a JCM5805 strain in the composition of each sample beverage.

<Evaluation Criteria for Degree of Suppression of Stuck Feeling in Throat after Drinking>

The degree of suppression in comparison to the sample beverage that did not contain a JCM5805 strain;
1: suppressed
2: slightly suppressed
3: not suppressed

In addition, five trained sensory evaluators sensory-evaluated the overall flavor of each of the sample beverages of Test Examples 10 to 16 as absolute evaluation based on the following evaluation criteria. The results are shown in Table 4 below.

### <Evaluation Criteria for Overall Flavor>

1: good
2: slightly good
3: slightly poor
4: poor

Furthermore, the results of evaluating the sample beverages of Test Examples 10 to 16 by the sensory evaluators without being bound by the evaluation criteria are shown in the comment column of Table 4.

TABLE 4

| | Test Example | | | | | | |
|---|---|---|---|---|---|---|---|
| | 10 | 11 | 12 | 13 | 14 | 15 | 16 |
| JCM5805 | 1000 | 1000 | 1000 | 1000 | 1000 | 1000 | 1000 |
| strain | | | | | | | |
| (100 million | | | | | | | |
| cells/100 mL) | | | | | | | |
| pH | 3.7 | | | | | | |
| Skim milk | 0.25 | 0.42 | 0.9 | 1.3 | 1.7 | 2 | 2.5 |
| powder (%) | | | | | | | |
| Fermented | 0.5 | 0.8 | 1.0 | 2.1 | 3.1 | 5.2 | 5.2 |
| milk | | | | | | | |
| (sterilized) | | | | | | | |
| (%) | | | | | | | |
| Ratio (%) of | 100 | 100 | 100 | 100 | 100 | 100 | 100 |
| non-fat milk | | | | | | | |
| solids | | | | | | | |
| content in | | | | | | | |
| milk solids | | | | | | | |
| content | | | | | | | |
| Milk solids | 0.3 | 0.5 | 1 | 1.5 | 2 | 2.5 | 3 |
| concentration | | | | | | | |
| (%) | | | | | | | |
| Stuck feeling | 3 | 2 | 1 | 1 | 1 | 2 | 3 |
| in throat | | | | | | | |
| Overall flavor | 2 | 1 | 1 | 1 | 1 | 2 | 2 |
| General | Stuck | Slight stuck | Stuck | Stuck | Stuck | Stuck | Strong |
| comments | feeling | feeling in | feeling was | feeling was | feeling was | feeling was | stuck |
| | in | throat was | suppressed | suppressed | suppressed | slightly | feeling was |
| | throat | felt in | | | | suppressed | felt in |
| | was not | control, and | | | | | control, and |
| | minded | suppression | | | | | suppression |
| | in | of stuck | | | | | of stuck |
| | control | feeling was | | | | | feeling was |
| | | felt in Test | | | | | hardly felt in |
| | | Example 11 | | | | | Test |
| | | | | | | | Example 16 |

As can be seen from the results in Table 4, when the milk solids concentration was 0.3 wt %, the stuck feeling in throat after drinking was not minded in the first place in the control, which did not contain a JCM5805 strain; thus, no suppression of stuck feeling was observed in the sample beverage of Test Example 10, which contained a JCM5805 strain. Further, when the milk solids concentration was 0.5 to 2.5 wt %, stuck feeling in throat after drinking was felt in the controls, which did not contain a JCM5805 strain. The evaluation of stuck feeling was 1 or 2 in each of the sample beverages of Test Examples 11 to 15, which contained a JCM5805 strain, and a suitable suppressive effect on stuck feeling was observed in any case. On the other hand, when the milk solids concentration was 3 wt %, there was a strong stuck feeling in the control, which did not contain a JCM5805 strain; thus, suppression of stuck feeling was hardly observed in the sample beverage of Test Example 16, which contained a JCM5805 strain.

The evaluation of the overall flavor was 2 (slightly good) or 1 (good) in all of the sample beverages of Test Examples 10 to 16.

As described above, when the milk solids concentration was 0.5 to 2.5 wt %, if a JCM5805 strain was incorporated, the evaluation of stuck feeling was 1 or 2, and a suitable suppressive effect on stuck feeling was obtained in any case; however, it was shown that from the viewpoint of a more suitable suppressive effect on stuck feeling and the good balance of the overall flavor, the milk solids concentration was more preferably 1 to 2 wt %.

[Test 3] Influence of Type of Milk Raw Material on Stuck Feeling in Throat after Drinking Acidic Beverage

In Test 2 above, skim milk powder and fermented milk (sterilized) were used as milk raw materials. The following test was conducted to examine the influence on stuck feeling when the milk raw material was not a combination of skim milk powder and fermented milk (sterilized). Specifically, in this test, only skim milk powder was used as a milk raw material.

### (Preparation of Sample Beverages)

The components shown in Table 5 below were added and mixed with water at the blend concentrations shown in Table 5 to prepare sample acidic milk beverages 17 to 23, and the sample beverages were each placed in a container and subjected to heat sterilization treatment at 80° C. for 10 minutes. Skim milk powder was added at the addition rate (wt %) shown in Table 6. The milk solids concentration (wt %) of the sample beverages 17 to 23 and the ratio (wt %) of the non-fat milk solids content in the milk solids content were each as shown in Table 6. An appropriate amount of anhydrous citric acid was added to each sample beverage to adjust the pH to 3.7.

TABLE 5

| Component | Blend concentration (wt %) |
|---|---|
| JCM5805 strain | 100 billion cells/100 mL |
| Skim milk powder | shown in Table 6 |
| Fructose glucose liquid sugar | 13 |
| Soybean polysaccharide | 0.1 |
| Pectin | 0.1 |
| Flavoring | 0.1 |

### (Sensory Evaluation of Sample Beverages)

Five trained sensory evaluators sensory-evaluated whether the stuck feeling in throat after drinking the sample beverages of Test Examples 17 to 23 was suppressed, based on the following evaluation criteria. The results are shown in Table 6 below.

For example, the sensory evaluation of the degree of suppression of stuck feeling in the sample beverage of Test Example 17 was performed using, as a control, a sample beverage that did not contain a JCM5805 strain in the composition of the sample beverage of Test Example 17. The sensory evaluation of the sample beverages of Test Examples 17 to 23 was also performed using, as controls, sample beverages that did not contain a JCM5805 strain in the composition of each sample beverage.

<Evaluation Criteria for Degree of Suppression of Stuck Feeling in Throat after Drinking>

The degree of suppression in comparison to the sample beverage that did not contain a JCM5805 strain;
1: suppressed
2: slightly suppressed
3: not suppressed

In addition, five trained sensory evaluators sensory-evaluated the overall flavor of each of the sample beverages of Test Examples 17 to 23 as absolute evaluation based on the following evaluation criteria. The results are shown in Table 6 below.

### <Evaluation Criteria for Overall Flavor>

1: good
2: slightly good
3: slightly poor
4: poor

Furthermore, the results of evaluating the sample beverages of Test Examples 17 to 23 by the sensory evaluators without being bound by the evaluation criteria are shown in the comment column of Table 6.

TABLE 6

| | Test Example | | | | | | |
|---|---|---|---|---|---|---|---|
| | 17 | 18 | 19 | 20 | 21 | 22 | 23 |
| JCM5805 | 1000 | 1000 | 1000 | 1000 | 1000 | 1000 | 1000 |
| strain | | | | | | | |
| (100 million | | | | | | | |
| cells/100 mL) | | | | | | | |
| pH | 3.7 | | | | | | |
| Skim milk | 0.3 | 0.5 | 1 | 1.5 | 2 | 2.5 | 3 |
| powder (%) | | | | | | | |
| Ratio (%) of | 100 | 100 | 100 | 100 | 100 | 100 | 100 |
| non-fat milk | | | | | | | |
| solids | | | | | | | |
| content in | | | | | | | |
| milk solids | | | | | | | |
| content | | | | | | | |
| Milk solids | 0.3 | 0.5 | 1 | 1.5 | 2 | 2.5 | 3 |
| concentration | | | | | | | |
| (%) | | | | | | | |
| Stuck feeling | 3 | 2 | 1 | 1 | 1 | 2 | 3 |
| in throat | | | | | | | |
| Overall flavor | 2 | 1 | 1 | 1 | 1 | 1 | 1 |
| General | Stuck | Slight stuck | Stuck | Stuck | Stuck | Stuck | Strong |
| comments | feeling | feeling in | feeling was | feeling was | feeling was | feeling was | stuck |
| | in | throat was | suppressed | suppressed | suppressed | slightly | feeling was |
| | throat | felt in | | | | suppressed | felt in |
| | was | control, and | | | | | control, and |
| | not | suppression | | | | | suppression |
| | minded | of stuck | | | | | of stuck |
| | in | feeling was | | | | | feeling was |
| | control | felt in Test | | | | | hardly felt in |
| | | Example 18 | | | | | Test |
| | | | | | | | Example 23 |

When the results of Table 6, in which only skim milk powder was used as a milk raw material, and the results of Table 4, in which skim milk powder and fermented milk (sterilized) were used as milk raw materials, were compared between sample beverages with the same milk solids concentration, similar results were obtained for the degree of suppression of stuck feeling. Specifically, when the milk solids concentration was 0.5 to 2.5 wt %, stuck feeling in throat after drinking was felt in the controls, which did not contain a JCM5805 strain. The evaluation of stuck feeling was 1 or 2 in each of the sample beverages of Test Examples 18 to 22, which contained a JCM5805 strain, and a suitable suppressive effect on stuck feeling was observed in any case. Further, when the milk solids concentration was 3 wt %, there was a strong stuck feeling in the control, which did not contain a JCM5805 strain; thus, suppression of stuck feeling was hardly observed in the sample beverage of Test Example 23, which contained a JCM5805 strain.

The evaluation of the overall flavor was 2 (slightly good) or 1 (good) in all of the sample beverages of Test Examples 17 to 23.

As described above, when the milk solids concentration was 0.5 to 2.5 wt %, if a JCM5805 strain was incorporated, the evaluation of stuck feeling was 1 or 2, and a suitable suppressive effect on stuck feeling was obtained in any case; however, it was shown that from the viewpoint of a more suitable suppressive effect on stuck feeling and the good balance of the overall flavor, the milk solids concentration was more preferably 1 to 2 wt %.

### INDUSTRIAL APPLICABILITY

The present invention can provide an acidic milk beverage with suppressed stuck feeling in throat after drinking, a method for producing the same, and the like. Further, as a more preferred embodiment of the present invention, it is possible to provide an acidic milk beverage with suppressed stuck feeling in throat after drinking while maintaining the overall flavor, a method for producing the same, and the like.

1-5. (canceled)

6. An acidic milk beverage comprising a Lactococcus lactis subsp. lactis JCM5805 strain and having a pH of 6 or less.

7. The acidic milk beverage according to claim 6, wherein a bacterial cell concentration of the JCM5805 strain in the acidic milk beverage is 5 billion cells/100 mL to 200 billion cells/100 mL.

8. The acidic milk beverage according to claim 6, wherein the acidic milk beverage has a milk solids concentration of 0.5 to 2.5 wt %.

9. The acidic milk beverage according to claim 7, wherein the acidic milk beverage has a milk solids concentration of 0.5 to 2.5 wt %.

10. A method for producing an acidic milk beverage having a pH of 6 or less, the method comprising a step of incorporating a JCM5805 strain in the production of the acidic milk beverage.

11. The method according to claim 10, wherein the JCM5805 strain is incorporated so that a bacterial cell concentration of the JCM5805 strain in the acidic milk beverage is 5 billion cells/100 mL to 200 billion cells/100 mL.

12. The method according to claim 10, wherein the acidic milk beverage is produced so that the acidic milk beverage has a milk solids concentration of 0.5 to 2.5 wt %.

13. The method according to claim 11, wherein the acidic milk beverage is produced so that the acidic milk beverage has a milk solids concentration of 0.5 to 2.5 wt %.

14. A method for suppressing stuck feeling in throat after drinking an acidic milk beverage having a pH of 6 or less, the method comprising a step of incorporating a JCM5805 strain in the production of the acidic milk beverage.

15. The method according to claim 14, wherein the JCM5805 strain is incorporated so that a bacterial cell concentration of the JCM5805 strain in the acidic milk beverage is 5 billion cells/100 mL to 200 billion cells/100 mL.

16. The method according to claim 14, wherein the acidic milk beverage is produced so that the acidic milk beverage has a milk solids concentration of 0.5 to 2.5 wt %.

17. The method according to claim 15, wherein the acidic milk beverage is produced so that the acidic milk beverage has a milk solids concentration of 0.5 to 2.5 wt %.
